(19) United States
(12) Patent Application Publication
(10) Pub. No.: US 2013/0322697 A1
(43) Pub. Date: Dec. 5, 2013

(54) Speed Calculation of a Moving Object based on Image Data

(71) Applicants: Gene A. Grindstaff, Decatur, AL (US); Sheila G. Whitaker, Gurley, AL (US)

(72) Inventors: Gene A. Grindstaff, Decatur, AL (US); Sheila G. Whitaker, Gurley, AL (US)

(73) Assignee: HEXAGON TECHNOLOGY CENTER GMBH, Heerbrugg (CH)

(21) Appl. No.: 13/485,369

(22) Filed: May 31, 2012

(51) Int. Cl. G06K 9/00

(52) U.S. Cl. 382/107

(57) ABSTRACT

A method and system for estimating the average speed of a moving object based on an attribute of the moving object present within the captured image data is disclosed. A plurality of images of the moving object are recorded using an image sensor that senses the ambient light or other electromagnetic radiation reflected or emitted by the moving object. Each image is captured at a different capture time. The image sensor is preferably located at a fixed or substantially fixed location when imaging the moving object. An area of interest of the moving object is located within the image data of the first image. An attribute of the moving object is then calculated for the first image. For at least a second image, the same attribute is calculated for the same area of interest of the moving object. The attribute calculations for the first and at least second images are then used to determine the average speed of the moving object. The attribute may be the cross-sectional area of the area of interest of the moving object.

### TECHNICAL FIELD

The present invention relates to calculation of the speed of a moving object, and more particularly to the calculation of speed based upon image data of the moving object.

### BACKGROUND ART

It is known in the prior art to measure the speed of a moving object by measuring the distance traveled by the object at different points in time. Thus, the speed can be represented as V=ΔD/ΔT. Speed can also be calculated by the vehicle itself by using a speedometer that measures the rotation of the vehicle's wheels. Thus, RPM (revolutions per minute) of the wheels can be converted to speed.

Devices have also been created to measure the speed of a vehicle external from the vehicle including radar guns and light detection and ranging detectors (e.g. laser detectors or LIDAR). These devices transmit a signal (radio wave or laser beam) that is reflected back to a sensor. For radar guns, changes in frequency between the transmitted and received signals are determined. The change in frequency corresponds to the speed of the vehicle in accordance with the well-known Doppler effect. Radar guns are most effective when a single vehicle is present on a road way and the radar gun is directed in the direction of movement of the moving vehicle. Radar guns are ineffective in high traffic areas because of contamination of the radar signal by the other vehicles in both the sending and receiving directions.

LIDAR is more effective alternative to radar in high traffic areas, since both the transmitted and reflected beams are quite narrow. Both radar guns and LIDAR speed guns are subject to being detected by radar and laser detectors because they both require transmission of a signal that can be sensed.

In order to avoid the need of transmitting a signal that can be detected, other techniques have been used to determine the speed of vehicles. In one prior art system, sensors (e.g. pressure sensors, lasers etc.) are separated by known distances and the time between sensors being tripped is measured to determine the speed. Such a system requires that only one vehicle is present between the two sensors in order to obtain an accurate speed measurement. Another prior art system uses photography to measure the speed. Two or more markers are placed along a roadway and cameras take pictures of the vehicle as the vehicle passes the markers. Thus, in a similar fashion to the previous system, the distance is a known quantity and the time between the markers is determined by the image acquisition times. This system improves on the prior art, in that multiple vehicles may pass through the markers, but because the photographs show the vehicles, a user can differentiate between vehicles and more accurately measure a vehicles speed. This system requires preparation and setup of the roadside markers at predetermined distances in order for photography to be used for measuring a vehicles speed.

### SUMMARY OF THE EMBODIMENTS

In a first embodiment of the invention there is provided a method for estimating the average speed of a moving object. A plurality of images of the moving object are recorded using an image sensor that senses the ambient light or other electromagnetic radiation reflected or emitted by the moving object. Each image is captured at a different capture time. The image sensor is preferably located at a fixed or substantially fixed location when imaging the moving object. An area of interest of the moving object is located within the image data of the first image. An attribute of the moving object is then calculated for the first image. For at least a second image, the same attribute is calculated for the same area of interest of the moving object. The attribute calculations for the first and at least second images are then used to determine the average speed of the moving object. In one embodiment of the invention, the attribute is color information of the area of interest. In another embodiment, the attribute may be geometric, such as the area, or measurement of some component of the moving object. In yet another embodiment of the invention, the speed of the vehicle is determined solely by the attribute of the vehicle without reference to data other than the image data and acquisition time for the images. The invention as embodied in a system may include a processor and associated computer program code.

In certain embodiments of the invention, image data representative of the object may be selected automatically by the processor. The image data representative of the object need not be data for the entire object and may only represent a portion of the object.

The image data representative of the object may be automatically selected based upon a determination of a unique color range within the image data. For example, the color may be associated with the headlights or tail lights of a moving vehicle. Additionally, the image data may be determined based upon a substantially similar distance calculation. In such an embodiment, pixel locations having similar colors within a defined criteria would be selected. A distance estimation tool, such as a calculation module employing the Koschmeider equation to determine the transmitivity of each pixel and associated distance may be employed to determine distances that are substantially similar. For example, pixel values that are a first distance say 300 ft, 310 ft, 298 ft may be grouped together, but another pixel value with either an infinite distance or a negative distance would be excluded, since the pixel is likely part of the background and not part of the moving vehicle. The substantial similarity of the distance measurements depends on the accuracy of the distance measurement tool for measuring the distance of the image data. Thus, if there is an expectation of a 10% error for the measurement, image data outside of 10% or 15% would not be considered to be substantially similar.

In certain embodiments of the invention, image data may be discarded if the image data for a pixel is below or above a threshold. For example, pixel values that represent black on a scale of 256 that are below 15 generally are not perceptible to the human eye and therefore, this data may be discarded when determining a unique color within the area of interest. The hue of the pixels within the area of interest may be used to identify the moving object. For example, the maximum hue within the area of interest may be determined and then a range of colors may be set. For example, a percentage, such as 80%, 90% etc. may be used for defining a color tolerance range within which pixels will be identified as being part of the moving vehicle for comparison. The tolerance range determines which pixels within the images are discarded. The image data for the remaining pixels is then used to determine the area of interest of the object in each image. The speed of the object can be determined based upon the change in the area of interest at different times i.e. between different pictures. The speed of the object can be determined by as few as two images, but preferably benefits from averaging over multiple images. A linear regression technique can be used to determine the average speed.

It should be understood that the methodology may be employed in either real-time or after image acquisition and that the methodology can be implemented in a processor associated with software code. The software code may be stored on a tangible medium, such as a computer disk or in memory. The system may include a camera and associated processor with computer code thereon. The methodology, system, and computer program product can be implemented so that the distance of the moving object need not be determined in order to determine the speed of the object. Relative distance measurements for the image data at pixel locations can benefit the accuracy of the calculation.

In an alternative embodiment of the invention, the attribute of the moving vehicle may be the pixel color data wherein the transmitivity vector for the pixels of an area of interest of the moving object are determined. From the transmitivity vector, the distance from the point of acquisition to each pixel can be calculated. An average distance may be determined for the pixels of a area of interest. By taking images at different times while the object is moving, the velocity of the moving object can be easily determined.

As with other embodiments of the invention, the area of interest of the moving object may be determined automatically. The area may be associated with a location on a display that is displaying an image of the moving object e.g. a digital camera with a built-in display. In one embodiment, the location is a central area of the display. The area of interest of the moving object may be all or a sub-set of the moving object. A computer algorithm may scan the image data to identify a unique color and range of colors. From this range of colors, image data may be selected as the area of interest of the moving object. Thus, a shape, such as a square, may define the area of interest, but the actual pixels present in the area of interest may be less than the number of pixels within the initial area. A car may have a taillight that is bright red and the area of interest may be a square that includes the taillight. A unique color within the area of interest, for example, the maximum red value (i.e. color or hue) for the taillight may be determined. From this selected color, pixels having a similar intensity within approximately 90% of the original color are selected to be included and identified as being the area of interest of the moving object. The percentage value may vary depending on the uniqueness of the color within the area of interest. The area of interest of the object as defined by the remaining pixel can then be used to determine the transmitivity of the pixels and also the distance of the pixels from the acquisition position.

The transmitivity related to the pixel values and the cross-sectional area of a portion of the moving object are examples of image data attributes that can be used for determining the speed of the moving object. Other attributes, such as the width or length of a an element of the moving vehicle may be preknown e.g. the height of the tailpipe for a Chevy Cobalt. This information can then be used to determine the speed of the vehicle wherein the measurement, is a scalable attribute. Embodiments of the invention do not require information other than the actual image data, the image acquisition time, and the F number for the lens that acquired the image data in order to determine the speed.

Embodiments of the invention may employ a digital camera that is coupled to a tripod for stability. Other embodiments of the invention may include a hand-held camera or a dashboard mounted camera. The more stable the camera the less noise that will be recorded during the image acquisitions and therefore, the more accurate the speed will be.

It should be recognized that any of the disclosed methods may be used to determine the speed of a vehicle in real-time (due to the mathematical simplicity of the calculation) or at a time after the images have been acquired.

Determining the area of interest of the moving object between images may be achieved by employing a tracking algorithm. Thus, a centrally located square that is used as the starting point of the area of interest may move and/or be resized to account for movement of the area of the object of interest. As previously indicated, the initial area of interest may be defined by a predefined shape at a predefined location, but the true area of interest may be only a sub-set of the shape. As the object moves from image to image, the size of the area of interest will vary. Therefore, the size of the initial shape for capturing the area of interest may change between images in order to account for the changes in size of the area of interest between images.

### BRIEF DESCRIPTION OF THE DRAWINGS

The foregoing features of embodiments will be more readily understood by reference to the following detailed description, taken with reference to the accompanying drawings, in which:

FIG. 1 shows an object that is moving, such as a car.

FIG. 1A shows a typical display as used in a digital camera for capturing an image of an object;

FIG. 1B shows a representation of a car in which an area of interest is selected for the moving object;

FIG. 2 represents a moving object wherein the area of interest is a circle;

FIG. 3 shows a flow diagram wherein temporally acquired image data is used to determine the speed of a moving object captured by the image data;

FIG. 3A is a flow chart that describes an embodiment of the invention in which color data of the moving object is the attribute;

FIG. 3B graphically represents the geometry between an acquiring camera and a moving object when a known measurement of the moving object is known;

FIGS. 4A-D show sample screen shots of the application operating in a “smart” phone environment that includes a camera;

FIG. 4A shows a first screen shot wherein the user is asked to select between live video and a stored file;

FIG. 4B shows a second screen shot inquiring as to the camera that acquired the video images from a stored file;

FIG. 4C shows a third screen shot showing a bounding region (reticle) for defining the area of interest;

FIG. 4D shows a fourth screen shot showing a marker that indicates the center of the moving object and the currently calculated speed;

FIG. 5 shows a flow chart with an example of the tracking algorithm in conjunction with determining the speed calculation for a moving object;

FIGS. 6A-6C show video images of a moving vehicle wherein the bounding box is initially a square;

FIG. 6A shows a video image of a moving vehicle wherein the bounding box includes the left rear taillight of the moving vehicle;

FIG. 6B shows the area of interest of the moving vehicle within the bounding region at time T0; and

FIG. 6C shows the area of interest of the moving vehicle within the bounding region at time T1.

### DETAILED DESCRIPTION OF SPECIFIC EMBODIMENTS

Definitions. As used in this description and the accompanying claims, the following terms shall have the meanings indicated, unless the context otherwise requires:

An “image” is defined as the resulting data acquired by a sensor that senses the light or radiation reflected or generated by an object. For example, an image sensor may acquire information about sensed light including intensity and color information over the area of the sensor. The information may be converted into digital data and the digital data defines a digital image. The acquiring sensor need not be a light sensor and may be any type of known sensor including an infrared detector, an x-ray detector, a gamma ray detector etc. that senses information where the information can be converted into digital data.

The term “substantially fixed” implies that the object i.e. camera does not move significantly relative to its initial position when averaged over time in at least one dimension. The fixed position for a camera may be associated with its GPS coordinates in one embodiment of the invention. The image sensor that is acquiring the digital image may be within a digital camera or cell phone. The camera may be held by a user at a position and the position of the camera may have small relative movements and thus, still be considered to be located at a substantially fixed position. For example, picture shake that occurs and is generally controlled by image stabilization algorithms would be within the range of movement as understood by the term substantially fixed. In other contexts, the term “substantially fixed” implies that the camera does not move relative to its coupling, thus if the camera is coupled to the dashboard of a moving car, the camera is substantially fixed relative to the mount.

The present invention in one embodiment is directed to a methodology for determining the speed of a moving object using only a series of images of the moving object captured over a period of time. Embodiments of the methodology do not require a direct line-of-sight for the camera that acquires the images nor does the methodology require that the moving object travel across a level plane in order to determine the speed. Additionally, the distance of the object from the camera sensor does not need to be determined in order to obtain the speed of the object. The images may be captured using a video capture device or using a high-resolution still frame camera that obtains images in rapid succession. No additional sensors or data are required to obtain the velocity of the object although information such as GPS coordinates and sensor information from gyroscopes coupled to the camera could be used to augment the disclosed methodology and improve the speed and accuracy of the velocity calculation. The embodiments of the methodology may be used as an alternative to “radar and laser detectors” that are often employed by law enforcement. The embodiments of the present invention do not require the creation of a signal and the beaming of the signal at the moving object in order to determine the speed of the object. Rather only light or other radiation needs to be sensed by an image sensor. Therefore, a driver/passenger of the moving object can neither detect embodiments of the speed sensing system nor can they jam or block a beamed signal as is done with radar detectors, laser detectors and speed jamming equipment. At present there is no known method for disrupting the capture of an image that can legally be employed by a motorist.

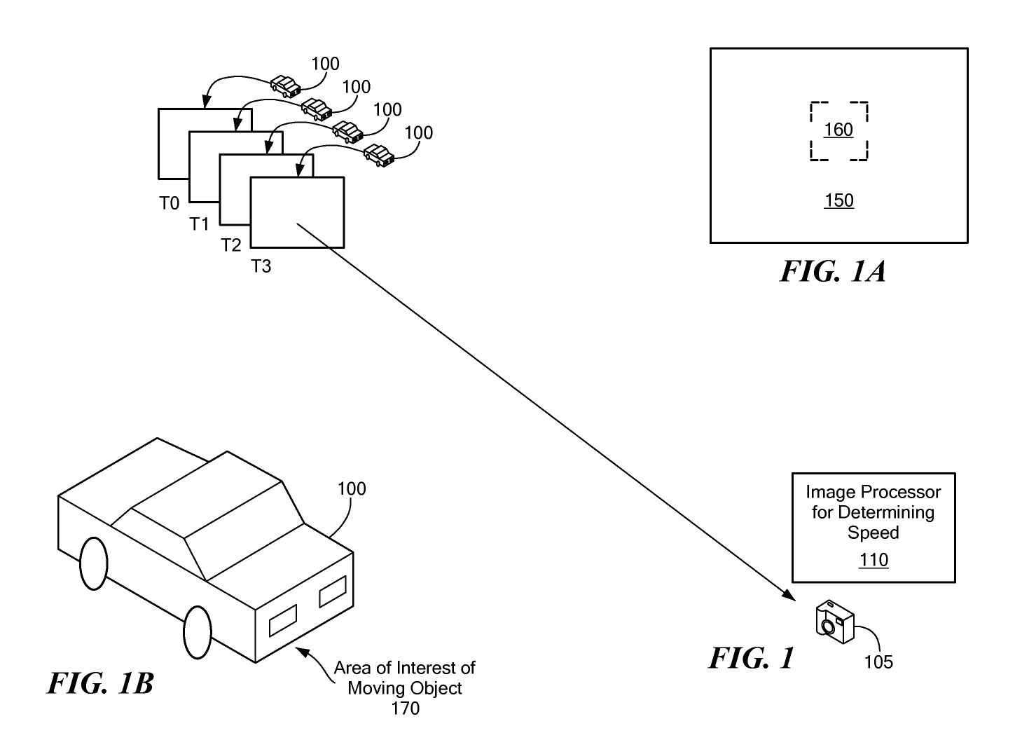

FIG. 1 shows an object 100 that is moving, such as a car. A camera system 105 acquires images of the car either moving toward the camera as shown or moving away from the camera. The images are acquired at discrete points in time (T0, T1, T2, T3) and the acquisition time of each image is stored by an image processor 110 associated with the acquiring image sensor of the camera to memory. The acquisition time and the image data of the acquired image of the moving object are associated together. The image processor may be part of the camera and similarly the camera may be part of the image processor (i.e. a cellular telephone having a processor and associated camera). FIG. 1A shows a typical display 150 as used in a digital camera for capturing an image of an object. The display 150 includes a reticle 160 for centering the object or area of interest of the object. In one embodiment of the invention, the reticle 160 corresponds to a central location on the display. During acquisition of the digital images, the camera 105 is positioned toward the object 100. The camera 105 may be manually positioned or held by a user or mounted to a fixed or moving platform. The reticle 160 identifies an initial area of interest 170 of the moving object 100. The system acquires an attribute of the moving vehicle within the initial area of interest. An attribute may be a geometric attribute, such as an area of the vehicle, a height or width of a portion of the vehicle or any other measure that changes with speed. Once the attribute is captured in the first image, the processing system determines the same attribute in one or more subsequent frames. FIG. 1B shows a representation of a car 100 in which an area of interest 170 is selected for the moving object 100. As shown, the left headlight is selected as the area of interest. It should be recognized that the reticle 160 defines an initial area of interest 170 and the actual area of interest may be a sub-set of the data within the reticle. For example, the reticle may include data representative of the left headlight 170, but may also include data representative of a car's bumper. In certain embodiments, the data that represents the area of interest may be limited based upon the color information within the reticle. If a headlight or taillight is part of the area of interest, the methodology may focus on the color red or yellow depending on the state and type of light. Thus, portions of the object within the reticle, with distant color characteristics may be eliminated The methodology described below provides different means for discerning the desired area of interest of the object, so that the same area of interest of the object may be defined between images.

The image processor 110 of FIG. 1 receives the camera information and operates to determine the speed of the moving object 100. In one embodiment of the invention, the processor includes logic for tracking the area of interest within the sequential set of images.

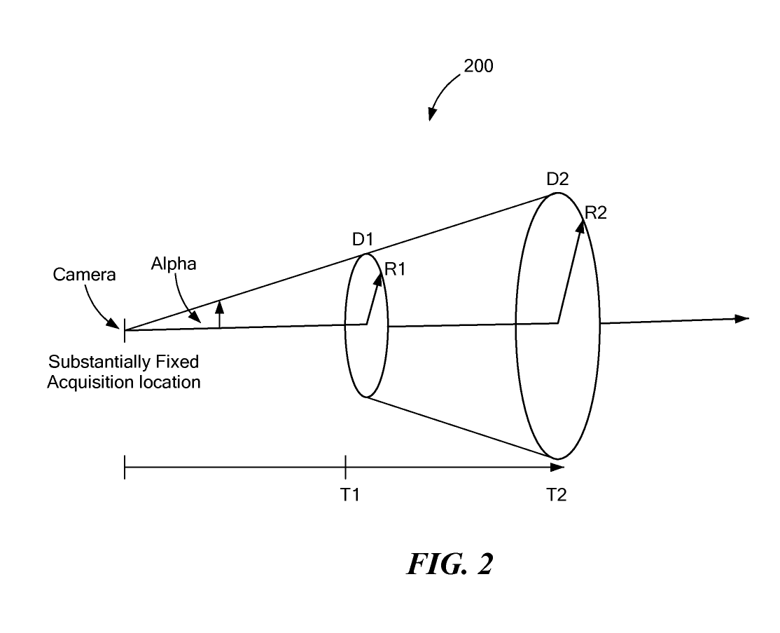

FIG. 2 represents a moving object at different points in time wherein the area of interest is a circle 200. Although the area of interest is represented as a circle, the area of interest could be represented with other shapes (e.g. squares, rectangles etc.). At time T1 the area of interest of the moving object as acquired by a camera from position 0 has characteristics R1 (Radius) as represented by the number of pixels and the area of interest has an associated distance D1. At time T2, the area of interest has the characteristics of R2 (radius) and area of interest of the moving object has an associated distance D2 from the image acquisition position. The area of the first circle can be described by:

Δ1=πR1² And Δ2=πR2²

Where R1=sqrt (A1/π) And R2=sqrt(A2/π)

Thus, the tangent of the angle Alpha can be described as Tangent (Alpha)=R1/D1=R2/D2 Or R1=D1*Tangent(Alpha) And R2=D2*Tangent(Alpha)

Substituting the area for the radius yields:

sqrt(A1/π)=D1*Tangent(Alpha)

and

sqrt(A2/π)=D2*Tangent(Alpha)

Solving for the distance yields:

D1=sqrt(A1/π)/Tangent(Alpha)

And

D2=sqrt(A2/π)/Tangent(Alpha)

Speed=Distance/Time

Thus the speed from time “T1” to “T2” is:

Speed=(D2−D1)/(T2−T1)=(sqrt(A2/π)/Tangent(Alpha)−sqrt(A2/π)/Tangent(Alpha))/(T2−T1)

Or

Speed=(sqrt(A2)−sqrt(A1))/(sqrt(π)*Tangent(Alpha)*(T2−T1)

Where the “sqrt(π)” and the “Tangent(Alpha) are just a constant that represents the parameters of a given camera configuration. Thus, for a given camera the formula becomes:

Speed=K*(sqrt(A2)−sqrt(A1))/(T2−T1)

As a result, the speed of the moving vehicle can be determined without knowing the distance of the moving object from the camera at each acquisition time. Rather, a measurable change, such as a change in the cross-sectional area or other attribute that varies with speed can be used to determine the speed of the moving object.

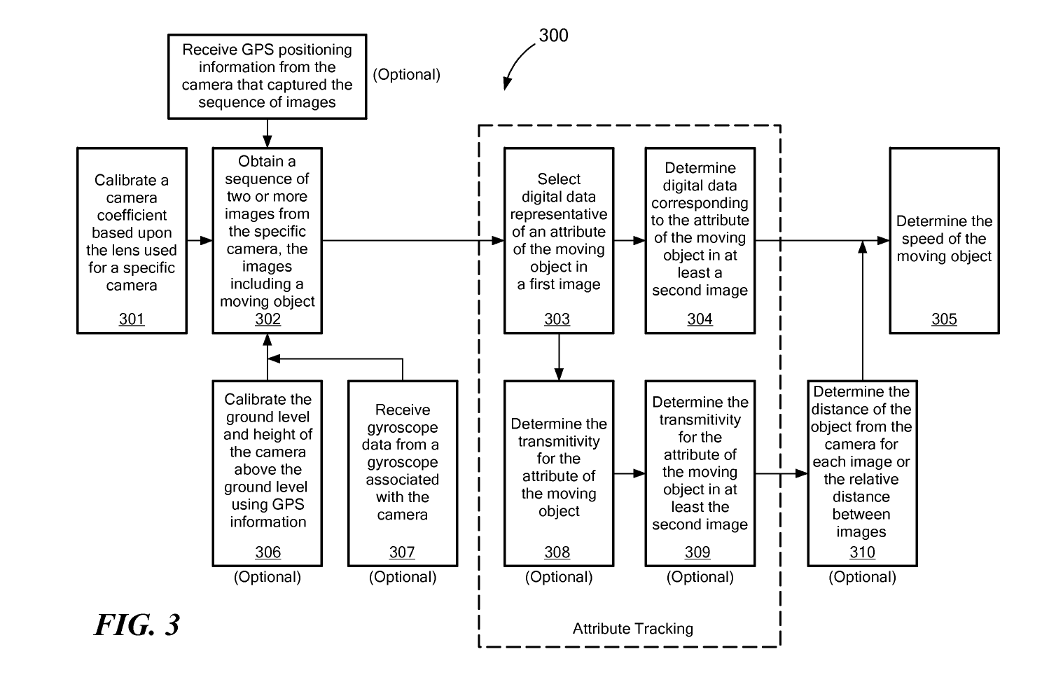

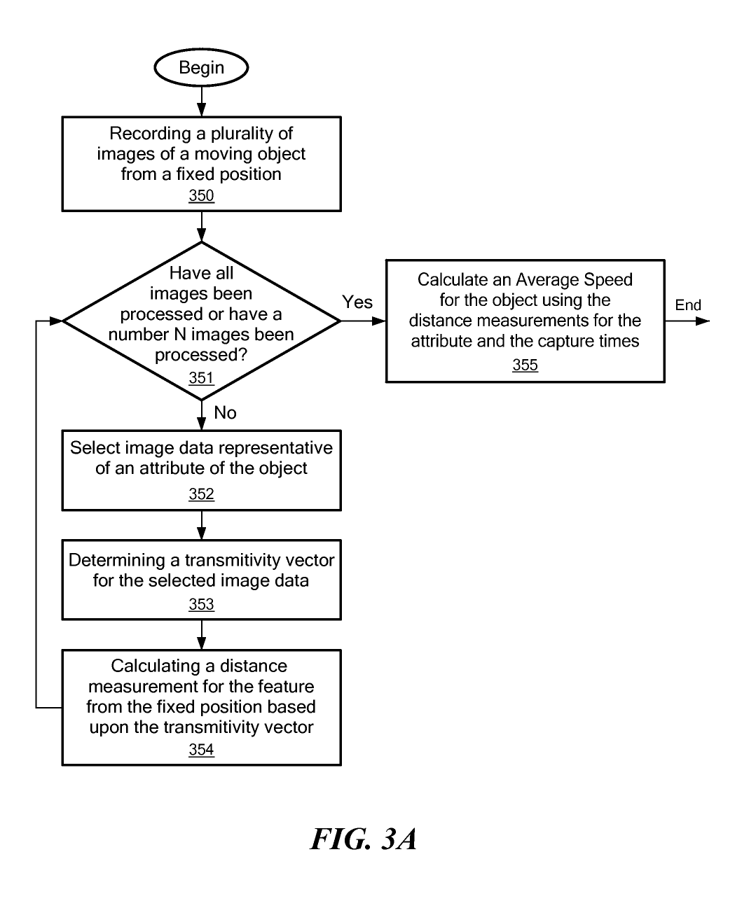

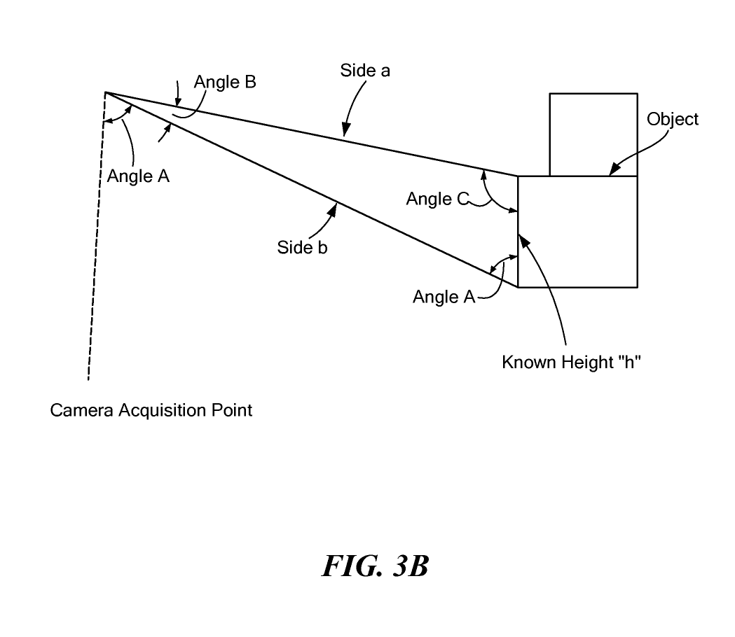

FIG. 3 shows a flow diagram 300 wherein temporally acquired image data is used to determine the speed of a moving object. First, a camera lens constant K is calibrated 301. 300 For example, for a fixed lens and therefore, a fixed focal length, a value for K can be determined through testing and used in the speed determination calculation above. Calibration can be performed by using the camera lens to be calibrated to capture a series of images of a vehicle moving at a known speed. Once the images are acquired and the area of interest is determined in the different images, the value of K can be calculated by substituting the known speed and area values in the above speed equation. The calibration constant K for a variety of lenses can be predetermined and stored to memory for later access. If the focal length changes, as for example with an autofocus zoom camera, the constant K can be linearly weighted to compensate for the change in the focal length from the original calibration constant K. Thus, K varies inversely with the F number of a given lens. As understood by one of ordinary skill in the art, the F-number is the ratio of the lens's focal length to the diameter of the entrance pupil (effective aperture) Once the calibration constant is determined, a camera sensor senses a moving object creating a plurality of temporally spaced images 302. For example, the images may be sensed at 1/60^{th} of a second intervals. An attribute of the moving object is selected in the first image 303. The attribute may be automatically selected or user selected. For example, a user may focus on a portion of the moving object and identify to the system that the portion of the object is the initial area of interest. For automatic selection, the system may include an image edge detector that identifies one or more edges for selection of the area of interest, or simply the center of the imaging sensor may be selected as the area of interest, which presumes that the camera is directed at the moving object. For example, a reticle as displayed on a display of a digital camera may define the initial area of interest. Once the initial area of interest is determined within the first image, the area of interest in corresponding images is determined 304. As expressed above, one method may include an attribute tracking algorithm for identifying the center of the area of interest in subsequent images. The attribute tracking algorithm may be based upon determining the centroid of the area of interest in each image. Other known tracking algorithms can be used without deviating from the scope of the invention. Thus, a bounding region can be used that may be the same size or larger than the reticle described above. The attribute tracking algorithm will find the centroid in each subsequent image that corresponds to the image data within the bounding region of the initial image. As the proper center of the bounding region is determined for each subsequent image an algorithm (to be described) can be applied to determine pixels that are part of the area of interest from the total number of pixels within the bounding region. In other embodiments, the system presumes that the moving object does not move much between video frames and that the area of interest will stay within a predefined section of the image sensor. As such, the bounding region is static i.e. at a fixed addressable location.

In order to determine the speed of the moving object, the attribute, which in the present example is an area of interest, is compared between the two or more frames to determine how the areas have changed in size (relative number of pixels) 305. In one embodiment, a bounding region for the area of interest is used and then a predetermined threshold is chosen for the elimination of pixels. For example, all pixels below an arbitrary threshold, for example 80 on a scale of 255 may be removed from the bounding box. This processing step is done in order to eliminate noise from the bounding box. Other processing for the elimination of noise may be performed without deviating from the spirit of the present invention. For example, a linear regression for determining the number of pixels found within a plurality of images will reduce noise. Additionally, a pixel tolerance may be used The hue for each image is then placed on a histogram which may be created without any visual output. The maximum hue (i.e. the dominant hue) of the remaining pixels within the bounding region is determined by a computer process. In an alternative embodiment, a user may be prompted to select the dominant hue from a histogram that is graphically displayed. After the maximum hue is determined, the value at which the Hue falls off by a percentage such as 10% of its maximum value is determined. Pixel values that reside between the maximum hue and 10% of the maximum hue are preserved. All other pixel values are eliminated. The total number of pixels remaining within the bounding region is a representation of the cross-sectional area of the area of interest. Once the number of pixels is determined for each image, a comparison can be made between the number of pixels. It should be recognized that the bounding algorithm between the maximum and 10% of the maximum is only one example for determining the common area of interest shared within the bounding box of the images. It should be understood by one of ordinary skill in the art that there are other techniques for determining data that belongs to a come area of a moving object as shown in multiple digital images.

In the presently described embodiment of the invention, the number of pixels would be expected to increase in number if the moving object and therefore, the area of interest is moving toward the camera. The number of pixels for the area of interest would be expected to decrease in number if the moving object is moving away from the camera.

It should be recognized that the cross-sectional area of the area of interest in the first image can be calculated based upon a user selection of the area wherein the area of interest may be all of the pixels within a reticle defined on the display of the camera and the process for determining the number of pixels within the bounding region for subsequent images may be performed as just described (based on the hue). In other embodiments, a user selects an area of interest visually, by placing a portion of the moving object within a reticle and the system automatically determines a bounding region along with hue values for the first image and subsequent images and uses the disclosed methodology for determining the number of pixels within the area of interest along with the difference in the total number of pixels.

The speed of the moving object is finally determined based upon the change in the size of the area of interest as the vehicle moves. It should be understood by one of ordinary skill in the art that averaging over multiple frames the differences between the number of pixels may be used to obtain a more accurate average speed for the vehicle and to eliminate noise. Further, refinements of the algorithm can be made to more accurately determine the speed and to expunge noise and system error from the calculations. For example, noise may be increased and therefore the accuracy of the measurement effected if the number of pixels for an area of interested is determined to be small and/or there is a scan line drop out in the area of interest such that pixels are either improperly included within the area of interest or improperly removed from the area of interest, thereby impacting the speed calculation.

Noise can be reduced by avoiding compression algorithms during the capture of the sequence of images, thereby removing compression artifacts from the overall noise. Additional noise can be caused by quantization errors. Additional errors can be caused by movement of the camera during acquisition of the images. As a result, image stabilization will decrease the signal to noise ratio. Optical image stabilization can be used, as well as digital signal processing. Further, the camera can be mounted to a tripod or other stable platform to avoid camera shake. In tests, the accuracy of the speed measurements has been in the low single digit percentiles.

It should also be recognized that the vehicle and camera are assumed to be in a straight line during acquisition. However, the speed can still be determined if the camera is not in direct alignment wherein the projection of the vehicle can be obtained using geometry.

Additional, but optional steps may be employed in order to increase the accuracy of the speed measurement. When the area/number of pixels is being determined pixels may be removed from the calculation by determining a transmitivity measurement for each of the pixels and a corresponding depth measurement. If any of the pixels within the bounding box produce a different depth measurement (e.g. above a threshold of difference), these pixels can be eliminated. For certain areas of interest, it is presumed that the object has the same proximate depth and therefore, any pixels that are outside of the threshold having a near infinite depth can be eliminated as not contributing to the moving object, but rather the pixels are part of the background (infinite field of view). The well-known Koschmeider equation can be used to determine the transmitivity of the pixels and the corresponding depth. Examples of determining the transmitivity and depth of pixel values within an image are disclosed in U.S. patent application Ser. No. 13/030,534 having the title Fast Haze Removal and Three Dimensional Depth Calculation. This application is included herein by reference in its entirety.

Electronic devices, such as cellular telephones, known as “smart phones” often incorporate multiple sensors and processors such as GPS chips, IMUs (inertial measurement units, gyroscopes, and tilt sensors. The data from these sensors and processors can be used to refine the speed calculation. For example, if the moving object is not in-line with the camera, then a direction vector can be used to determine the object's speed along the path it is traveling rather than the speed relative to the camera. The direction vector can be determined based upon the Euler angles from an IMU (inertial measurement unit) along with the field of view (i.e. the F number of a fixed focus camera). Additionally, the GPS information allows for calculation of the ground level and the height of the camera above ground level 306. Gyroscope and tilt sensors can provide angle information about the angle of the camera relative to the ground plane 307. This information can be used to augment the above formula. For example, if the ground is assumed to be level and the height of the camera is known or acquirable, and the tilt of the camera is known from a tilt sensor, geometry can be used to determine the distance between the camera and the moving object Additionally, the Yaw, Tilt, and Roll can be easily factored into the formula using basic geometric principles.

In another embodiment of the invention, the attribute being measured is the adjusted color of the object based upon the transmitivity of the environment FIG. 3A is a flow chart that describes this embodiment of the invention. A plurality of images of a moving object are recorded using an image sensing device from a fixed position 350. The images may be previously recorded or recorded in real-time. The system checks to see if the all of the images have been processed 351. If all of the images in the sequence have not been processed and a number of image N have not already been processed, image data representative of an attribute of the object that changes with speed is selected from the image. An area of interest is selected of the moving object 352. The area of interest may be the entire moving object, but for practical applications, the area of interest is a portion of the moving object. More specifically, the area of interest is the pixel color values for the area of interest. The transmitivity of each pixel value for an area of interest can be calculated for a given image 353. (See FIG. 3 308) Based on the determined transmitivity, the depth can be determined for the pixels within the area of interest. An average depth can then be found for the image by averaging the depth measurements of the pixels within the area of interest. The depth value can then be calculated for the area of interest for a second and subsequent image (See FIG. 3 309), where each image is acquired at a different time. In this instance, the depth value represents the distance from the camera sensor to the area of interest of the moving object 354. Once the distance and acquisition times are known for multiple images (for example a number N or the last image has been processed, a calculation of the speed of the moving object can be determined where the speed is calculated as change in the distance divided by the change in time 355. (See also FIG. 3 310). Thus, in this embodiment, the distance measurement is used for calculating the speed of the moving object.

As previously stated, the attribute of the moving vehicle that is measured within the digital image data, need not be a total number of pixels, but may be an area, a dimension, or other characteristic of the moving object that temporally changes in accordance with speed. The color change of the moving object over a plurality of temporally sampled images can be considered an attribute.

Additionally, if a real-world measurement is known for the vehicle (e.g. the height from the ground of the license plate for a particular vehicle) and the height of the camera during image acquisition from a reference point, the tilt angle of the camera, and the camera constant are known, the distance of the moving vehicle from the camera can be determined for each photo using the following equations and the geometry of FIG. 3B. A height “h” of the moving object is known. Angle A is obtained from the tilt sensor in the camera. Angle B is calculated from A and the field of view as a percentage. Angle C=Angle A-Angle B. Using the law of cosines the sides of the triangle as defined by the camera acquisition position to each end point of the known height h can be determined. Once side a or side b of the triangle is known then angle A or A+B respectively can be used to determine the horizontal distance from the camera to the object where:

a/sin(A)=b/sin(B)=c/sin(C) Law of Cosines

Horizontal distance=b*sin(A)

Or

Horizontal distance=a*sin(A+B)

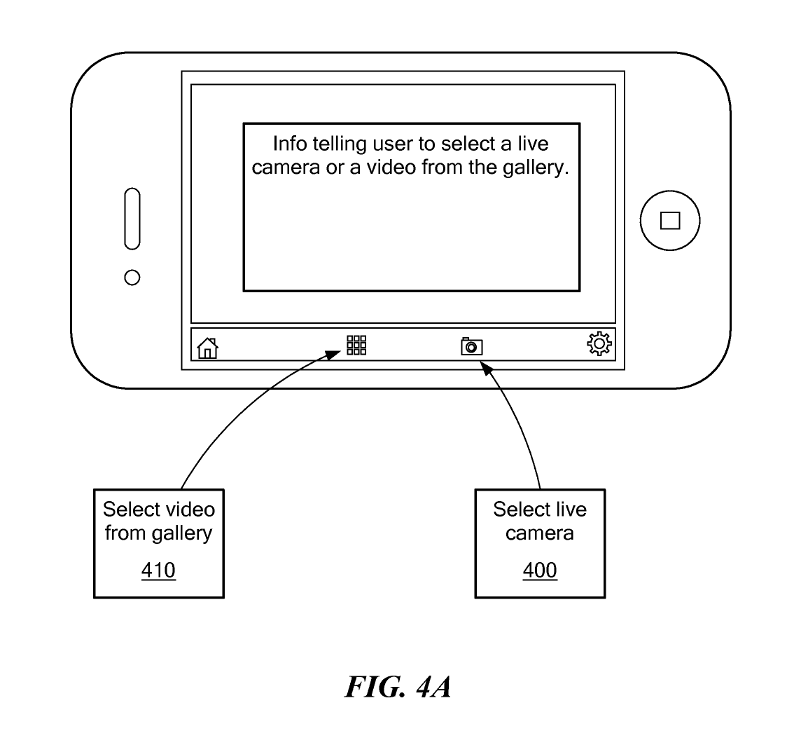

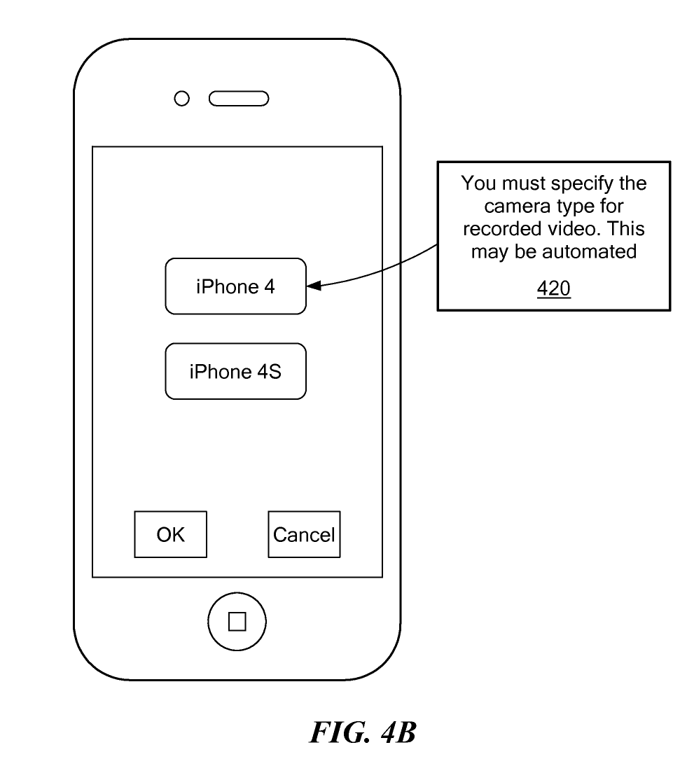

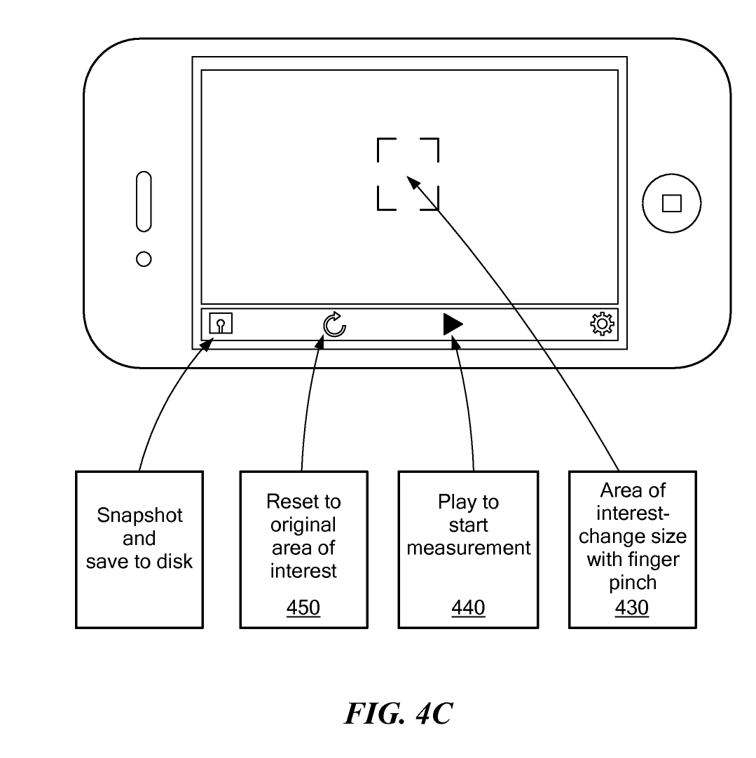

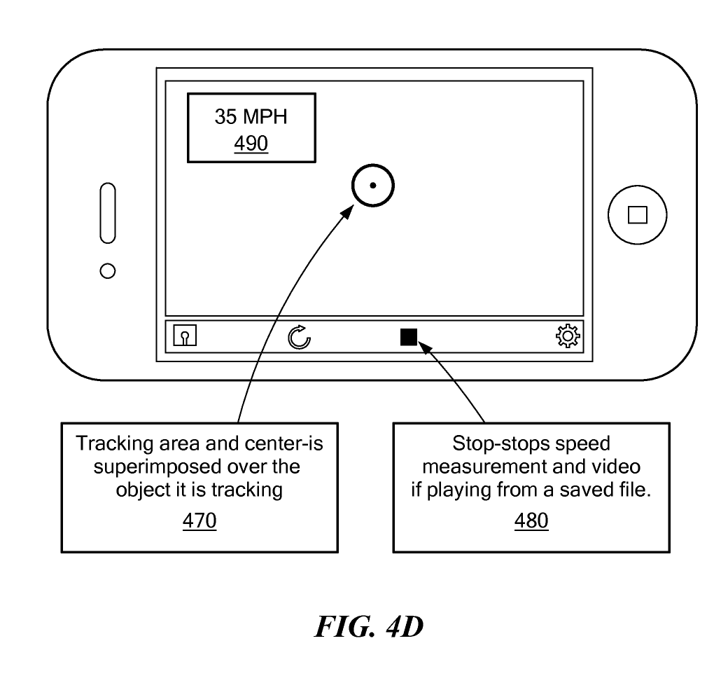

However, it should be recognized that the calculation of the distance of the vehicle is not necessary for determining the speed of the vehicle. The present method can be used to determine the speed of multiple vehicles that are present within a sequence of images and is not limited to the measurement of the speed of a single vehicle. The sequence of image may contain a plurality of vehicles and due to the unique colors of each moving object, an area of interest for each vehicle can be tracked and the change in the area of interest of each vehicle can be used to determine the speed of each vehicle. Different moving objects are tracked by having an initial bounding region for each vehicle upon start-up. The bounding region defines the initial area of interest. The tracking processes may be operated in parallel to remain fixed on the area of interest for each moving vehicle. Even if the vehicles cross paths, the tracking algorithm will maintain the direction of movement of the area of interest and speed calculations can be obtained. FIGS. 4A-D show sample screen shots of the application operating in a “smart” phone environment that includes a camera. The user is first asked to select either a live camera 400 view or a video 410 in FIG. 4A. If the user selects a stored video, the user will be inquired as to the type of camera 420 that captured the video as shown in FIG. 4B. This information is required to select the proper camera constant from a database based upon the lens of the camera (focal length) used to capture the video. In FIG. 4C the user has selected to use the live camera and is presented with a reticle 430 for defining a bounding region in which an area of interest of the moving object resides. If the internal camera is used for the device, the camera lens is known and automatically selects the proper camera constant from the database. The user can resize the area of interest in one embodiment by using the touch screen device to enlarge or make smaller the reticle. The program allows the user to begin capturing images by selecting a start button 440. The user also has the ability of interacting with an icon for resetting the area of interest and resetting the area of interest if the user has changed the reticle size from the initial setting. 450. FIG. 4D shows a tracking FIG. 4D shows a circle 470 that is superimposed over the object while the camera is acquiring video and moves with the object based upon a tracking algorithm. The circle designates the center (e.g. centroid) of the moving object for the current image. The captured images (e.g. video) can be stopped at any time 480. The speed is presented on the screen in real-time 490. The speed may be the average speed over a number of video frames or the final speed if the video capture is stopped.

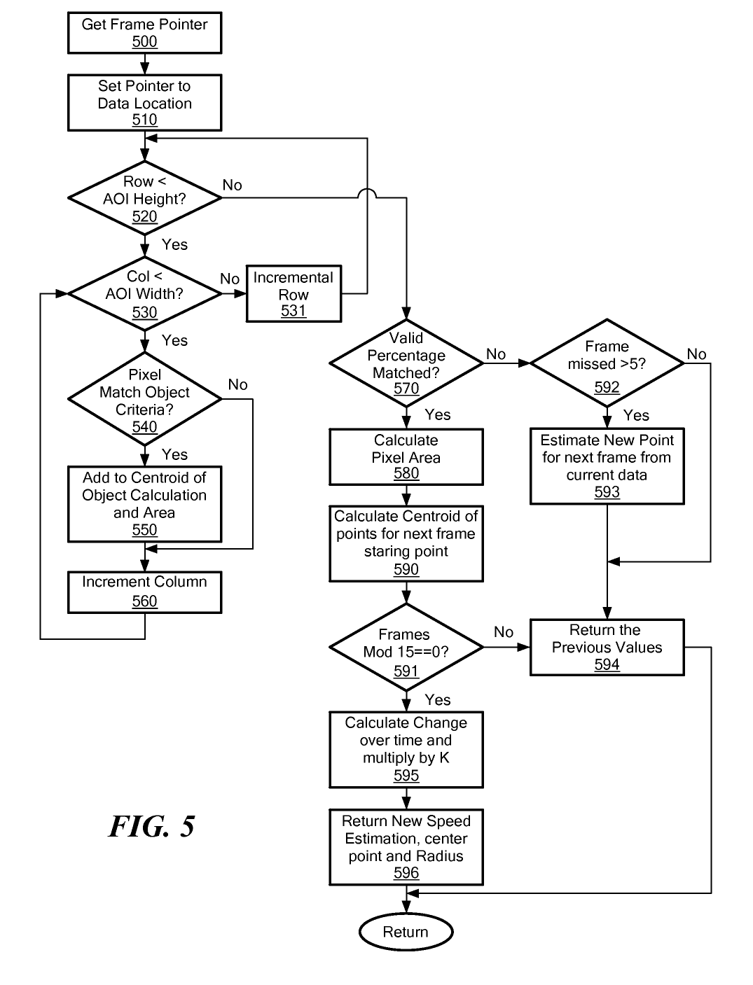

FIG. 5 shows a flow chart with an example of the tracking algorithm in conjunction with determining the speed calculation for a moving object. When the algorithm starts, a bounding box defines the area of interest of the moving object. The algorithm assumes that the moving object is at or near the center of the bounding box. As the process proceeds, the area of interest changes in size as the object changes in size.

At first, a processor running the algorithm obtains a frame pointer 500 and sets the frame pointer to the center of the screen 510. The processor then determines if the number of already processed rows is smaller than the area of interest. 520. If the answer is yes then the system inquires whether the number of processed columns (i.e length) is less than the width of the area of interest 530. If the number of processed columns is greater than the width of the area of interest 530 (i.e. the answer is no) the row number is incremented 531 and the system loops. If the answer is yes, the computer program checks to see if the present pixel matches the criteria for the area of interest 540. For example, is the color of the pixel within the range between the maximum hue of the area of interest from the first image and 10% of the maximum hue of the area of interest. If the pixel matches the criteria i.e. the answer is yes, the pixel is added to the calculation of the centroid of the object of interest 550 and the column is incremented 560. If the number of rows already processed is greater than the height of the area of interest, then the algorithm determines if there are a valid number of matched pixels in order to provide a meaningful speed result 570. For example, if there are fewer than a threshold number of pixels identified as the area of interest, for example, 20 or less, then the system presumes that there is an insufficient match between the original area of interest from the first image frame and the area of interest from the present image. In one embodiment, the threshold is not a number of pixels, but rather a ratio of the number of pixels found in the current image and the number of pixels in the previous image If a drastic change occurs, an image may have been lost or distorted. For example, if the moving object becomes obstructed, the area of interest may be temporarily lost or reduced significantly in size. As a result, the ratio between the number of pixels in the current image and the last image will be a low number It should be recognized that the threshold can be any measure that determines a significant change in the number of pixels or a loss of information between images regarding the area of interest. If the number of pixels is properly matched i.e. above a threshold or the ratio of the number of pixels is found to exceed a threshold, the pixel area is calculated for the image 580. The centroid of the pixels is then calculated at used as the starting point for processing the next image. The methodology next acquires 15 video frames before providing an update of the speed, so as to reduce noise in the calculation. The computer system determines if data for 15 frames has been acquired 591. If the answer is no, the system returns the previous speed value 594. If the answer is yes, the change in the area of interest over time is determined 595. The system then outputs the new speed preferably to display device. All previously discussed embodiments are not intended as limitations but serve as examples illustrating features and advantages of the invention. It is to be understood that some or all of the above described features can also be combined in different ways. Other tracking algorithms could be used as are known in the art without deviating from the scope of the invention. Haar features and likewise, the Sobel operator and box filters among other tracking algorithms may be employed.

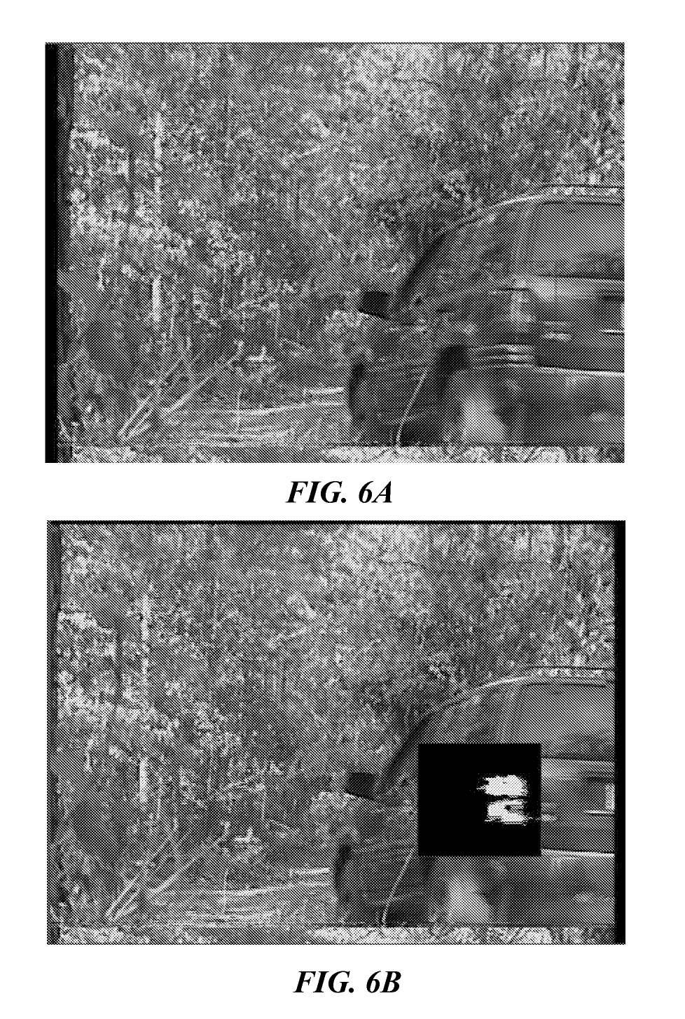

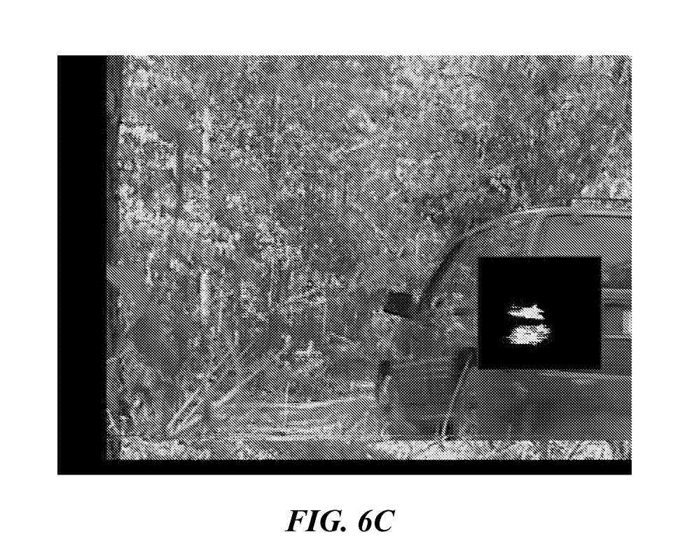

FIGS. 6A-C show video images of a moving vehicle. FIG. 6A shows a bounding region of the moving vehicle that identifies the area of interest at time T0. For this image, the rear left taillight is selected within the bounding region, which is a square in this example. FIG. 6B and FIG. 6C show the moving vehicle at two different times (T0 and T1) respectively. The bounding box shows the area of interest as white within the bounding box as provided by the above described algorithms wherein an attribute of the moving object is selected. In this example a dominant hue value is selected, which is the red color of the taillight. The pixel values within the bounding region that have colors within a predetermined range of the dominant hue are selected as begin part of the area of interest. The area of interest is designated in FIGS. 6B and 6C by the white within the bounding box. The areas of the white portion of the bounding boxes are then compared to determine the change in area (i.e. the number of pixels) between the two images. From the difference in areas, the speed of the vehicle can be determined.

It should be recognized by one of ordinary skill in the art that the foregoing methodology may be performed in a processing system and that the image processing system may include one or more processors for processing computer code representative of the foregoing described methodology. The computer code may be embodied on a tangible and non-transitory computer readable medium i.e. a computer program product.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an embodiment of the present invention, predominantly all of the reordering logic may be implemented as a set of computer program instructions that is converted into a computer executable form, stored as such in a computer readable medium, and executed by a microprocessor within the array under the control of an operating system.

Computer program logic implementing all or part of the functionality previously described herein may be embodied in various forms, including, but in no way limited to, a source code form, a computer executable form, and various intermediate forms (e.g., forms generated by an assembler, compiler, networker, or locator.) Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL.)

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A method for estimating speed of a moving object based upon a plurality of digital images comprising digital image data taken of the moving object from a substantially fixed position, where each image is captured at a different point in time, the method comprising:
identifying digital image data associated with an attribute of the moving object from a first digital image;
identifying image data associated with the attribute of the moving object from a second digital image; and
determining the speed of the moving object based upon the digital data associated with the attribute from the first and second digital images and the associated capture times.

2. A method according to claim 1 wherein the attribute relates solely to the moving object and is not related to the environment in which the object is moving.

3. A method according to claim 1 wherein the speed of the moving object is measured without determining any distance measurements between the substantially fixed position and the moving object.

4. A method according to claim 1 wherein the attribute is a geometric value for a portion of the moving object.

5. A method according to claim 1, wherein the attribute of the moving object varies with the speed of the moving object.

6. A method according to claim 1, wherein the digital image data representative of the object is automatically selected based upon at least a determination of a unique color range within the digital image data.

7. A method according to claim 1, wherein all digital image data for the attribute of the moving object below a threshold value are discarded prior to determining the speed of the moving object.

8. A method according to claim 1, further comprising:
determining a hue for the digital image data associated with the attribute of the moving object for at least the second digital image.

9. A method according to claim 8, wherein the determined hue is used to determine a tolerance range outside of which digital image data associated with the attribute from the first image and the second images are discarded.

10. A method according to claim 9, wherein remaining digital image data for the attribute associated with the moving object from the first image and the second images are used to determine a change in area of the attribute.

11. A method according to claim 9, wherein the change in area of the attribute is used in calculating the speed of the object.

12. A method according to claim 1, wherein the step of determining the speed is performed by a linear regression curve fitting of the digital image data for the attribute from at least the first image and the second image.

13. A method according to claim 1, further comprising:
determining the transmitivity for the digital image data associated with the moving object in at least the first image and the second image, wherein the attribute of the moving object is the transmitivity associated with the image data at a pixel location.

14. A method according to claim 13, wherein determining the speed uses the determined transmitivity and calculates distance measurements between the substantially fixed location and the moving object at each capture time.

15. A computer program product including a non-transitory computer readable medium having computer code thereon for estimating the average speed of a moving object, the computer code comprising:
computer code for accessing a plurality of images of the moving object from a fixed position wherein each image is captured at a different capture time;
for each image:
computer code for selecting image data representative of the object;
computer code for determining image data associated with an attribute of the object; and
computer code for calculating a speed measurement of the moving vehicle based at least upon the image data associated with the attribute of the moving object for each image and the associated capture time.

16. A computer program product according to claim 15 wherein the selection of the image data representative of an attribute of the object is performed automatically.

17. A computer program product according to claim 15, wherein the image data representative of the object may be a portion of the object.

18. A computer program product according to claim 15, wherein the attribute of the object is the cross-sectional area of a portion of the object.

19. A computer program product according to claim 18 wherein image data associated with the attribute is automatically selected based upon at least a determination of a unique color range for the image data of the attribute.

20. A computer program product according to claim 15, further comprising: computer code for determining a hue for the image data associated with the attribute of the moving object for at least a second image.

21. A computer program product according to claim 20, wherein the determined hue is used to determine a tolerance range outside of which image data associated with the attribute from a first image and the second images are discarded.

22. A computer program product according to claim 21, wherein remaining digital image data for the attribute associated with the moving object from the images are used to determine a change in area of the attribute.

23. A computer program product according to claim 22, wherein the change in area of the attribute between images is used in calculating the speed of the object.

24. A computer program product according to claim 15, wherein the computer code for calculating the speed is performed by a linear regression curve fitting of the digital image data for the attribute for the images.

25. A computer program product according to claim 15, further comprising: computer code for determining the transmitivity for the image data associated with the attribute of the moving object, wherein the attribute of the moving object is the transmitivity associated with the image data at a pixel location.

26. A computer program product according to claim 25, wherein the computer code for determining the speed uses the determined transmitivity and includes computer code for calculating distance measurements between the substantially fixed location and the moving object at each capture time.

27. A method for estimating the average speed of a moving object, the method comprising:
recording digital image data representative of at least a selected portion of the object at a first time from a substantially fixed position;
recording digital image data representative of at least the selected portion of the object at a second time from the substantially fixed position;
determining a cross-sectional area based on the digital image data for the selected portion of the object at the first time and the second time; and
calculating an average speed of the object based upon the determined cross-sectional area of the portion of the object and the associated capture times for the images.

28. The method according to claim 27 wherein recording a plurality of images is performed using a camera coupled to a base.

29. The method according to claim 28 wherein the base is a tripod

30. The method according to claim 27 wherein recording the digital data is performed using a camera held by a user.

31. The method according to claim 27, wherein the camera is part of a portable electronic device

32. The method according to claim 27, further comprising:
displaying the speed of the object on a display of an electronic device

33. The method according to claim 27 wherein the recording device includes a display, the display having a plurality of pixel locations.

34. The method according to claim 27 wherein the portion of the object at the first time is predefined by an area of the display defined by the pixel locations.

35. A method according to claim 27, further comprising:
determining hue of the portion of the object at the first time.

36. A method according to claim 27 wherein determining the cross-sectional area further comprises determining the hue of the digital image data for the portion of the object.

37. A method according to claim 36, further comprising: eliminating digital image data outside of a range based upon the determined hue.

38. A method according to claim 37 wherein determining the cross-sectional area for a portion of the object is done based upon the digital image data remaining after eliminating digital data outside of the range.
